(19) United States
(12) Patent Application Publication
(10) Pub. No.: US 2015/0381900 A1
(43) Pub. Date: Dec. 31, 2015

(54) ELECTRONIC DEVICE, INFORMATION CONTROL METHOD, AND NON-TRANSITORY COMPUTER-READABLE RECORDING MEDIUM

(71) Applicant: CASIO COMPUTER CO., LTD, Tokyo (JP)

(72) Inventors: Keiichi Kaneko, Kawasaki-shi (JP); Nobuo Iizuka, Tokyo (JP); Masaaki Kikuchi, Tokyo (JP)

(21) Appl. No.: 14/753,308

(22) Filed: Jun. 29, 2015

(30) Foreign Application Priority Data
Jun. 30, 2014 (JP) 2014-133876

(51) Int. Cl. H04N 5/265; H04N 5/232; G06K 9/46

(52) U.S. Cl. CPC H04N 5/265; G06K 9/4661; H04N 5/23293

(57) ABSTRACT

An electronic device includes: a range setter which sets a range for searching an image of light from an information source included in an image; and an informer which makes informed the range set by the range setter.

### CROSS-REFERENCE TO RELATED APPLICATION

This application claims the benefit of Japanese Patent Application No. 2014-133876, filed on Jun. 30, 2014, the entire disclosure of which is incorporated by reference herein.

### FIELD

This application relates generally to an electronic device, an information control method, and a non-transitory computer-readable recording medium.

### BACKGROUND

Techniques of processing captured time-series images (frames) for optical communication have been known.

For example, as described in Unexamined Japanese Patent Application Kokai Publication No. 2007-147994, when an outdoor illumination device or the like is used as a transmitter emitting light modulated with information, it is possible to acquire the information by photographing the transmitter with a built-in camera of an electronic device and demodulating the light received by the electronic device.

### SUMMARY

Generally, for a smartphone application, given the same operation system platform, the same binary data are installed on all models. Therefore, the above optical communication process can be realized by a smartphone application.

The electronic device of the present disclosure comprises a range setter which sets a range for searching an image of light from an information source included in an image, and an informer which informs the range set by the range setter.

Furthermore, the information control method of the present disclosure comprises a range setting step of setting a range for searching an image of light from an information source included in an image, and an information step of informing the range set in the range setting step.

Furthermore, the non-transitory computer-readable recording medium of the present disclosure stores a terminal control program allowing the computer to function as a range setter which sets a range for searching an image of light from an information source included in an image, and an informer which informs the range set by the range setter.

### BRIEF DESCRIPTION OF THE DRAWINGS

A more complete understanding of this application can be obtained when the following detailed description is considered in conjunction with the following drawings, in which:

FIG. 1 is an illustration showing the configuration of an information provision system including a smartphone as an electronic device;

FIG. 2 is a diagram showing the configuration of the smartphone;

FIG. 3 is a flowchart showing the first operation of the smartphone;

FIG. 4 is an illustration showing a first exemplary display screen of the smartphone;

FIG. 5 is an illustration showing a second exemplary display screen of the smartphone;

FIG. 6 is a flowchart showing the second operation of the smartphone;

FIG. 7 is a flowchart showing the third operation of the smartphone; and

FIG. 8 is an illustration showing a third exemplary display screen of the smartphone.

### DETAILED DESCRIPTION

The electronic device, information control method, and terminal control program according to an embodiment of the present disclosure is described hereafter with reference to the drawing.

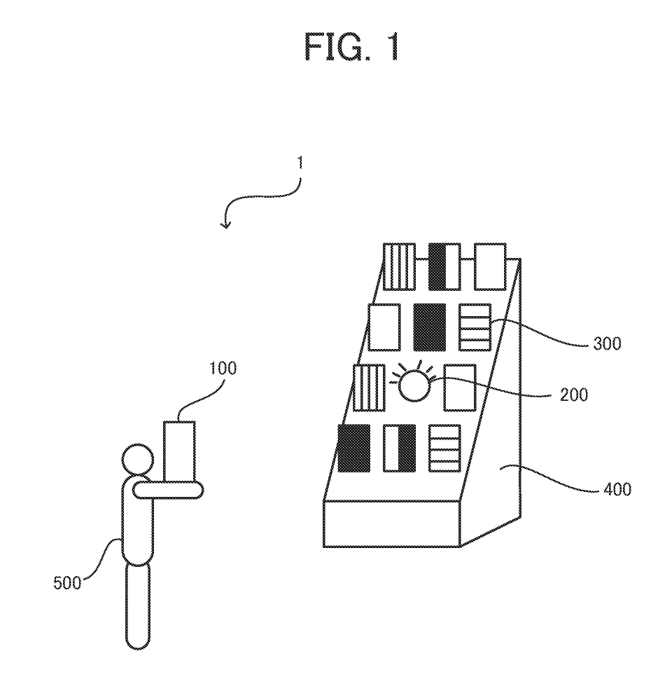

FIG. 1 is an illustration showing the configuration of an information provision system including the electronic device according to an embodiment of the present disclosure. An information provision system 1 shown in FIG. 1 comprises a smartphone 100 as an electronic device and an illumination device 200. As the smartphone 100 receives light from the illumination device 200, optical communication is conducted.

The illumination device 200 is installed on a product shelf 400 on which various products 300 are exhibited. The illumination device 200 emits light modulated in accordance with information (contents) relating to the products 300.

More specifically, the illumination device 200 encodes contents data to a bit data string and conducts digital modulation based on the bit data string. Any encoding scheme and modulation scheme can be used. A desirable modulation scheme is 4 PPM (pulse position modulation) using a frequency of 28.8 (kHz). Furthermore, the illumination device 200 creates drive signals to change the emitted light color (more specifically three colors, RGB) with time for transmission with multiple brightness values in accordance with the digital-modulated signals. A multicolor LED (light emitting diode) or the like is used as the light emitter.

The smartphone 100 is carried by a user 500. The smartphone 100 receives light from the illumination device 200 to acquire contents and displays the contents and the like.

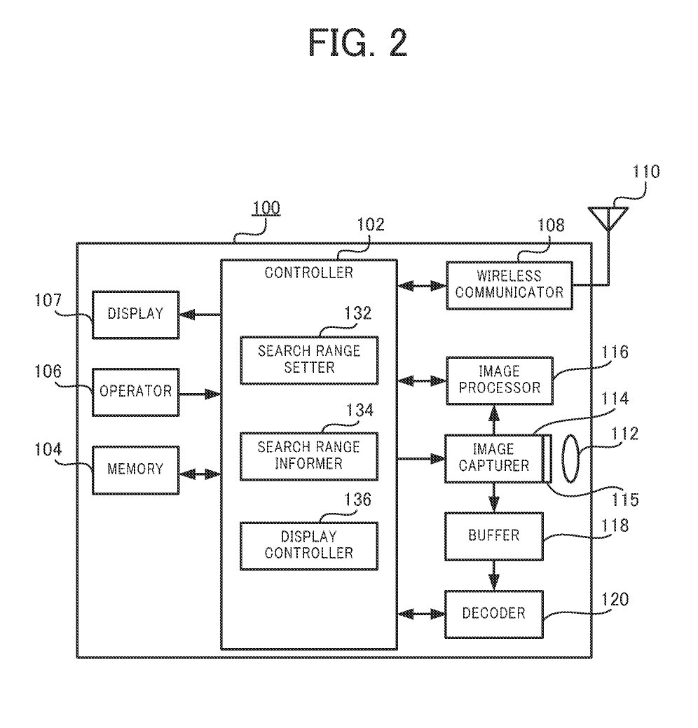

FIG. 2 is a diagram showing the configuration of the smartphone 100. As shown in FIG. 2, the smartphone 100 includes a controller 102, a memory 104, an operator 106, a display 107, a wireless communicator 108, an antenna 110, a lens 112, an image capturer 114, an image processor 116, a buffer 118, and a decoder 120.

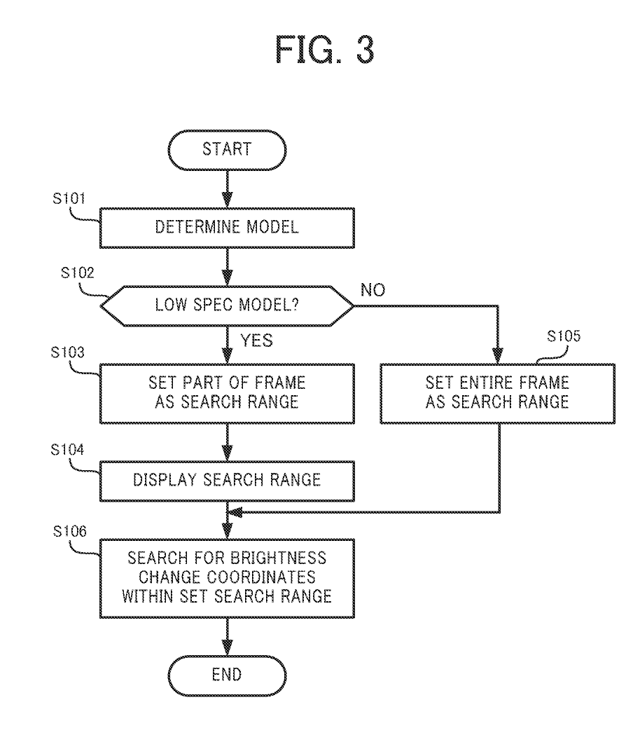

The controller 102 comprises a CPU (central processing unit). The controller 102 executes software processing according to programs (for example, programs for realizing the operations of the smartphone 100 shown in FIGS. 3 to 5, described later) stored in the memory 104 so as to control various functions (a search range setter 132, search range informer 134, display controller 136, and the like) of the smartphone 100. The memory 104 is, for example, a RAM (random access memory) or ROM (read only memory). The memory 104 stores various kinds of information (programs and the like) used for controls in the smartphone 100 and the like.

The operator 106 comprises a numerical keypad, function keys, and the like, and serves as an interface used for entering user operation details. The display 107 comprises, for example, an LCD (liquid crystal display), PDP (plasma display panel), EL (electroluminescence) display, or the like. The display 107 displays an image (for example, a live view image described later) according to image signals output from the controller 102.

The wireless communicator 108 is configured by using, for example, an RF (radio frequency) circuit, BB (base band) circuit, or the like. The wireless communicator 108 transmits/receives radio signals via the antenna 110. Furthermore, the wireless communicator 108 encodes and modulates transmission signals and demodulates and decodes reception signals.

The lens 112 comprises a zoom lens and the like. The lens 112 moves in accordance with zoom control operation through the operator 106 and focus control by the controller 102. The lens 112 is moved to control an imaging range and optical image of the image captured by the image capturer 114.

The image capturer 114 comprises multiple light-receiving elements regularly arranged in a two-dimensional array on a light-receiving surface 115. The light-receiving elements are an imaging device such as a CCD (charge coupled device) and CMOS (complementary metal oxide semiconductor). The image capturer 114 captures (receives light of) an optical image entering via the lens 112 with the imaging range in a given range based on control signals from the controller 102, and converts the image signals within the imaging range to digital data to create a frame. Furthermore, the image capturer 114 temporally successively captures an image and creates a frame, and outputs to the image processor 116, stores in the buffer 118 in sequence, and updates a succession of frames.

Furthermore, the image capturer 114 searches for a point in a frame at which the brightness is modulated. More specifically, the image capturer 114 determines the brightness at the same coordinates in each of a plurality of frames. As a result of the determination, if the brightness at specific coordinates within the imaging range changes so significantly in a given pattern that the brightness is equal to or higher than a first given value in some frames and equal to or lower than a second given value in other frames, the specific coordinates are assumed to be a point that occurs as a result of receiving light from the illumination device 200. Here, the search range for searching for such a point (an image of light from the illumination device 200) is a part of a frame in some cases, not in the entire frame. The processing when the search range is a part of a frame will be described later.

If such a point is present, the image capturer 114 decodes the coordinates of the point in the frames (“the brightness change coordinates,” hereafter) and the mode of temporal brightness change at the brightness change coordinates through a plurality of frames to a bit data string and stores and updates the bit data string in a coordinates data list configured in the buffer 118.

The image processor 116 adjusts the frame (digital data) output from the image capturer 114 in image quality and size based on control signals from the controller 102 for displaying as a live view image on the display 107 and outputs the frame. Furthermore, the image processor 116 has the function of encoding and filing an optical image within the imaging range of the image capturer 114 at the time of the recording order or within the display range on the display 107 in compliance with a compression coding scheme such as the JPEG (joint photographic experts group) when control signals based on a recording order operation from the operator 106 are entered. The display controller 136 within the controller 102 controls display of a live view image on the display 107 based on live view image data.

The decoder 120 decodes the bit data string presenting the mode of brightness change saved in the coordinates data list in the buffer 118 to digital data (contents data) and outputs the digital data to the controller 102 based on control signals from the controller 102. A decoding scheme corresponding to the encoding scheme of the illumination device 200 is used. The display controller 136 within the controller 102 controls display of an image of the contents on the display 107 based on the entered contents data.

The operation of the smartphone 100 upon optical communication will be described hereafter by way of the following first operation to third operation. The smartphone 100 conducts the following first to third operations when an optical communication application is executed.

(First Operation)

FIG. 3 is a flowchart showing the first operation of the smartphone 100 upon optical communication.

The search range setter 132 within the controller 102 of the smartphone 100 determines the model of the smartphone 100 (Step S101). More specifically, information of the model of the smartphone 100 is stored in the memory 104. The search range setter 132 acquires the model information stored in the memory 104.

Then, the search range setter 132 determines whether the determined model is a model lower than a reference processing capacity (a low spec model, hereafter) (Step S102). More specifically, as an optical communication application is executed, low spec model information is stored in the memory 104. The search range setter 132 determines whether the determined model information of the smartphone 100 matches the low spec model information.

If the model of the smartphone 100 matches the low spec model (Step S102; YES), then, the search range setter 132 sets a part of a frame as the search range for brightness change coordinates (Step S103). Here, the search range is rectangular. Information of the search range is presented by the coordinates of the four corners of a rectangle on the coordinate axes set on the frame and output to the image capturer 114.

Then, the search range informer 134 and display controller 136 within the controller 102 control display of the set search range (Step S104). More specifically, the display controller 136 displays a live view image on the display 107 based on live view image data from the image processor 116. Furthermore, the search range informer 134 creates data of a frame image presenting the outer edges of the search range and displays a frame image superimposed on the live view image on the display 107 based on the frame image data.

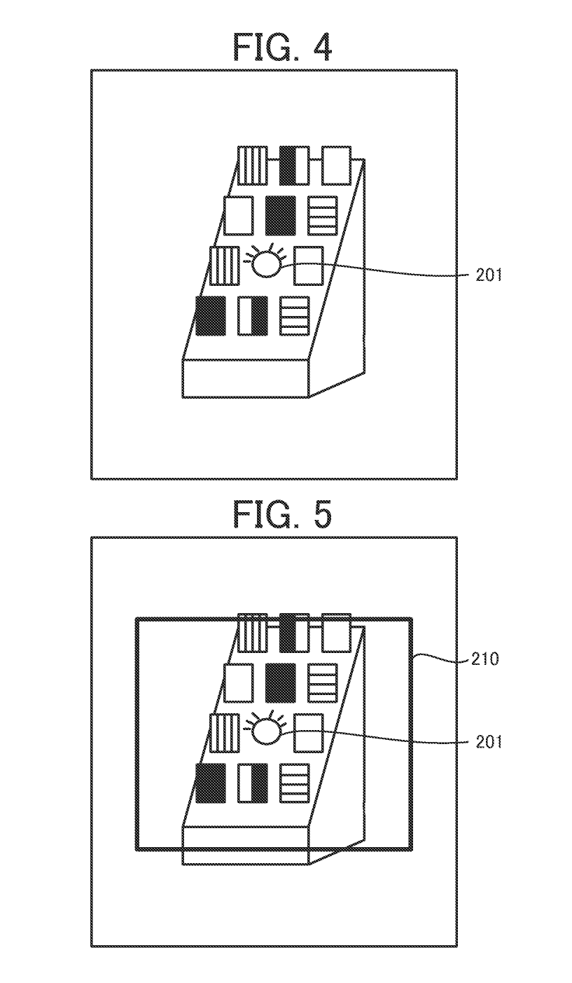

Consequently, only an image including an image 201 of the illumination device 200 (a live view image) is normally displayed as shown in FIG. 4. On the other hand, when a part of a frame is set as the search range for brightness change coordinates, a frame image 210 presenting the search range is displayed on an image including the image 201 of the illumination device 200 (a live view image) as shown in FIG. 5. In the case of the frame image 210 being displayed as shown in FIG. 5, if the image 201 of the illumination device 200 is not situated inside the frame image 210, the user 500 can move the smartphone 100 to change the photographing range so as to place the image 201 of the illumination device 200 inside the frame image 210.

On other hand, if the model of the smartphone 100 does not match the low spec model (Step S102; NO), then, the search range setter 132 sets the entire frame as the search range for brightness change coordinates (Step S105). Here, the search range is rectangular and information of the search range is presented by the coordinates of the four corners of a frame on the coordinate axes set on the frame and output to the image capturer 114.

After the search range is displayed in the Step S104 or after the entire frame is set as the search range in the Step S105, the image capturer 114 searches for brightness change coordinates within the set search range (Step S106). More specifically, the image capturer 114 determines the brightness at the same coordinates within the search range in each of a plurality of frames. As a result of the determination, if the brightness at specific coordinates within the imaging range significantly changes, the image capturer 114 assumes that the specific coordinates are the brightness change coordinates that occur as a result of receiving light from the illumination device 200, and stores and updates the brightness change coordinates in the frames and a bit data string presenting the mode of temporal brightness change at the brightness change coordinates through a plurality of frames in the coordinates data list configured in the buffer 118.

(Second Operation)

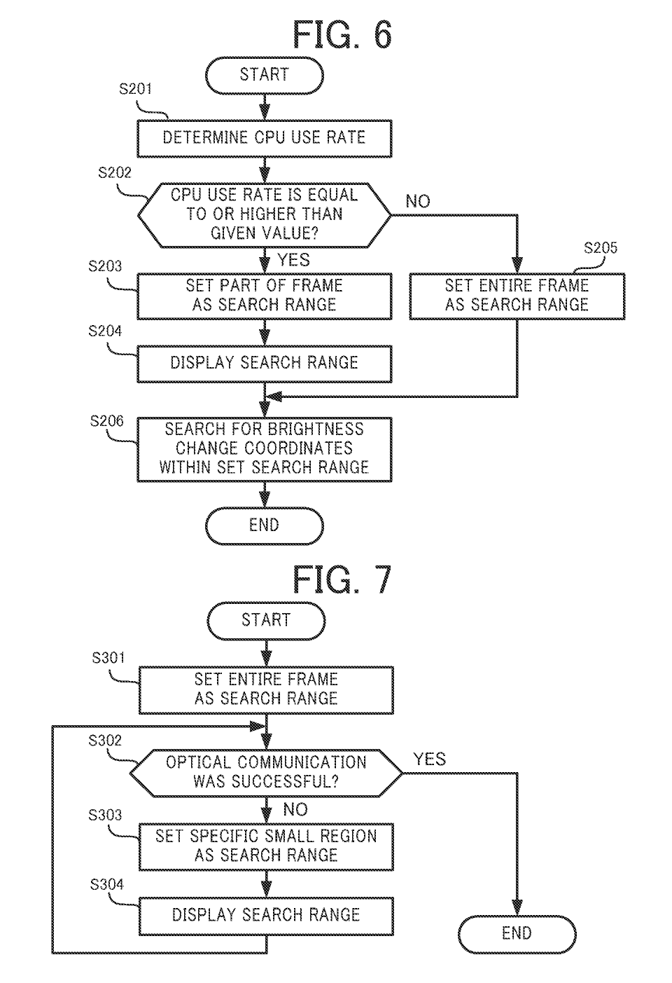

FIG. 6 is a flowchart showing the second operation of the smartphone 100 upon optical communication.

The search range setter 132 within the controller 102 of the smartphone 100 determines a CPU use rate of the CPU constituting the controller 102 (Step S201).

Then, the search range setter 132 determines whether the CPU use rate (resource occupancy) is equal to or higher than a given value (for example, 80%) (Step S202). More specifically, as an optical communication application is executed, information of the given value is stored in the memory 104. The search range setter 132 acquires the information of the given value stored in the memory 104 and determines whether the CPU use rate is equal to or higher than the given value.

If the CPU use rate is equal to or higher than the given value (Step S202; YES), then, the search range setter 132 sets a part of a frame as the search range for brightness change coordinates (Step S203). More specifically, as in the Step S103 of FIG. 3, the search range is rectangular and information of the search range is presented by the coordinates of the four corners of a rectangle on the coordinate axes set on the frame and output to the image capturer 114.

Then, the search range informer 134 and display controller 136 within the controller 102 control display of the set search range (Step S204). More specifically, as in the Step S104 of FIG. 3, the display controller 136 displays a live view image on the display 107 based on live view image data from the image processor 116. Furthermore, the search range informer 134 creates data of a frame image presenting the outer edges of the search range and displays a frame image superimposed on the live view image on the display 107 based on the frame image data. Consequently, as shown in FIG. 5, the frame image 210 presenting the search range is displayed on an image including the image 201 of the illumination device 200 (a live view image).

On the other hand, if the CPU use rate is not equal to or higher than the given value (Step S202: NO), then, the search range setter 132 sets the entire frame as the search range for brightness change coordinates (Step S205). As in the Step S105 of FIG. 3, the search range is rectangular and information of the search range is presented by the coordinates of the four corners of a frame on the coordinate axes set on the frame and output to the image capturer 114.

After the search range is displayed in the Step S204 or after the entire frame is set as the search range in the Step S205, the image capturer 114 searches for brightness change coordinates within the set search range (Step S206). More specifically, as in the Step S106 of FIG. 3, the image capturer 114 determines the brightness at the same coordinates within the search range in each of a plurality of frames. As a result of the determination, if the brightness at specific coordinates within the imaging range significantly changes, the image capturer 114 assumes that the specific coordinates are the brightness change coordinates that occur as a result of receiving light from the illumination device 200, and stores and updates the brightness change coordinates in the frames and a bit data string presenting the mode of temporal brightness change at the brightness change coordinates through a plurality of frames in the coordinates data list configured in the buffer 118.

(Third Operation)

FIG. 7 is a flowchart showing the third operation of the smartphone 100 upon optical communication.

The search range setter 132 within the controller 102 of the smartphone 100 sets the entire frame as the search range for brightness change coordinates (Step S301). As in the Step S105 of FIG. 3, the search range is rectangular and information of the search range is presented by the coordinates of the four corners of a frame on the coordinate axes set on the frame and output to the image capturer 114.

Then, the search range setter 132 determines whether the optical communication was successful (Step S302). In optical communication, the image capturer 114 searches for brightness change coordinates within the set search range. More specifically, as in the Step S106 of FIG. 3, the image capturer 114 determines the brightness at the same coordinates within the search range in each of a plurality of frames. As a result of the determination, if the brightness at specific coordinates within the imaging range significantly changes, the image capturer 114 assumes that the specific coordinates are the brightness change coordinates that occur as a result of receiving light from the illumination device 200, and stores and updates the brightness change coordinates in the frames and a bit data string presenting the mode of temporal brightness change at the brightness change coordinates through a plurality of frames in the coordinates data list configured in the buffer 118. On the other hand, if there are multiple sets of coordinates (regions) where the brightness significantly changes, the coordinates data list is not updated and the optical communication is unsuccessful. The search range setter 132 monitors update of the coordinates data list, and determines that the optical communication was successful if updated and that the optical communication was unsuccessful if not updated.

If the optical communication was successful (Step S302; YES), the series of operation ends. On the other hand, if the optical communication was unsuccessful (Step S302; NO), then, the search range setter 132 sets a specific small region that is a part of a frame as the search range for brightness change coordinates (Step S303). More specifically, the search range is circular, and information of the search range is presented by information of the coordinates of the center of a circle on the coordinate axes set on the frame and the radius of the circle and output to the image capturer 114.

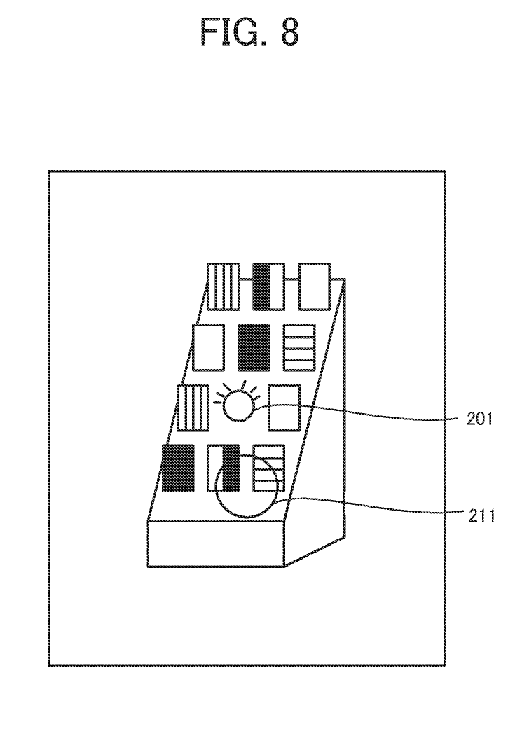

Then, the search range informer 134 and display controller 136 within the controller 102 control display of the set search range (Step S304). More specifically, as in the Step S104 of FIG. 3, the display controller 136 displays a live view image on the display 107 based on live view image data from the image processor 116. Furthermore, the search range informer 134 creates data of a ring image presenting the outer edge of the search range and displays a ring image superimposed on the live view image on the display 107 based on the ring image data. Consequently, as shown in FIG. 8, a ring image 211 presenting the search range is displayed on an image including the image 201 of the illumination device 200 (a live view image). In the case of the ring image 211 being displayed as shown in FIG. 8, if the image 201 of the illumination device 200 is not situated inside the ring image 211, the user 500 can move the smartphone 100 (or the lens 112 and image capturer 114) to change the photographing range so as to place the image 201 of the illumination device 200 inside the ring image 211.

Subsequently, the image capturer 114 searches for brightness change coordinates within the set search range through optical communication and repeats the determination of whether the optical communication was successful (Step S302) and subsequent operations.

As described above, the smartphone 100 sets a part of a frame as the search range for brightness change coordinates and searches for brightness change coordinates when the smartphone 100 is of a low spec model, the CPU use rate is equal to or higher than a given value, or the optical communication was unsuccessful. With the search range for brightness change coordinates being narrowed to a part of a frame, the smartphone 100 can search for brightness change coordinates without burden even if the smartphone 100 is of a low spec model or the CPU use rate is equal to or higher than a given value. Furthermore, even if there are multiple sets of brightness change coordinates and the optical communication was unsuccessful, successful optical communication can be achieved by narrowing the search range and thus narrowing down search-target brightness change coordinates.

The present disclosure is not confined to the above-described embodiment and drawings. The above-described embodiment and drawings can be modified as appropriate. In the above-described embodiment, when the smartphone 100 is of a low spec model, a part of a frame is set as the search range for brightness change coordinates. It is possible to determine whether the smartphone 100 is of a low spec model based on information with which the capability of the smartphone 100 is identified and when the smartphone 100 is of a low spec model, set a part of a frame as the search range for brightness change coordinates.

Furthermore, in the above-described embodiment, a part of a frame is set as the search range for brightness change coordinates when the CPU use rate is equal to or higher than a given value. It is possible to determine the processing state of the smartphone 100 based on information with which the processing state of the smartphone 100 can be identified other than the CPU use rate, for example the use rate of the memory 104, and when the processing state is tight, set a part of a frame as the search range for brightness change coordinates.

Furthermore, in the above-described embodiment, the smartphone 100 is used an electronic device. The present disclosure is applicable to any terminal capable of capturing an image such as cellphones, tablet-type personal computers, and note-type personal computers.

Furthermore, the function of the smartphone 100 can be realized, for example, by a computer executing the program. The program for realizing the function of the smartphone 100 can be stored on a non-transitory recording medium such as a CD-ROM (compact disc read only memory) or downloaded on a computer via a network.

A preferable embodiment of the present disclosure is described above. The present disclosure is not confined to this particular embodiment. The present disclosure includes the invention set forth in the scope of claims and the scope equivalent thereto.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An electronic device, comprising:
a range setter which sets a range for searching an image of light from an information source included in an image; and
an informer which informs the range set by the range setter.

2. The electronic device according to claim 1, wherein
the range setter sets the range in accordance with at least any of capability and processing state of the electronic device.

3. The electronic device according to claim 1, wherein
the informer displays the range.

4. The electronic device according to claim 1, comprising:
an image capturer,
wherein the range setter sets the range for searching the image of light from the information source included in the image obtained by image capturing of the image capturer.

5. The electronic device according to claim 4, wherein
the informer superimposes an image corresponding to the range on the image obtained by image capturing of the image capturer.

6. An information control method, comprising:
a range setting step of setting a range for searching an image of light from an information source included in an image; and
an information step of informing the range set in the range setting step.

7. A non-transitory computer-readable recording medium storing a terminal control program allowing the computer to function as:
a range setter which sets a range for searching an image of light from an information source included in an image; and
an informer which informs the range set by the range setter.
